(19) United States
(12) Patent Application Publication
(10) Pub. No.: US 2016/0063138 A1
(43) Pub. Date: Mar. 3, 2016

(54) Storage Medium Storing Simulation Program, Simulation Device, and Simulation Method

(71) Applicant: Kabushiki Kaisha Toshiba, Tokyo (JP)

(72) Inventor: Yumiko MIYANO, Tokyo (JP)

(73) Assignee: Kabushiki Kaisha Toshiba

(21) Appl. No.: 14/657,644

(22) Filed: Mar. 13, 2015

(30) Foreign Application Priority Data
Sep. 3, 2014 (JP) 2014-179560

(51) Int. Cl. G06F 17/50

(52) U.S. Cl. CPC G06F 17/50

(57) ABSTRACT

A storage medium storing a simulation program according to the present embodiment stores a simulation program for making a simulation device carry out a simulation of the shape of a semiconductor device. In accordance with the program, the simulation device simulates a manufacturing process using first three-dimensional shape data to calculate second three-dimensional shape data. Third three-dimensional shape data is calculated as a difference between the first three-dimensional shape data and the second three-dimensional shape data. Data about a calculation formula for calculating the second three-dimensional shape data from the first three-dimensional shape data by using the third three-dimensional shape data is generated. A data size of data including the data about the calculation formula and the third three-dimensional shape data is compared to a data size of the second three-dimensional shape data, and the data having a smaller data size is stored in the storage.

### CROSS REFERENCE TO RELATED APPLICATIONS

This application is based upon and claims the benefit of priority from the prior Japanese Patent Application No. 2014-179560, filed on Sep. 3, 2014, the entire contents of which are incorporated herein by reference.

### FIELD

Embodiments relate to a storage medium storing a simulation program, a simulation device, and to a simulation method.

### BACKGROUND

Miniaturization of semiconductor devices has advanced manufacturing processes and increased the number of processes, which makes it difficult to shorten a development period. Accordingly, in order to improve development efficiency, simulation is used in the development by modeling each process for a semiconductor device, for example.

In such a simulation, there may be a case where three-dimensional shape of the semiconductor device in each process is displayed. In such a case, three-dimensional shape data in each process should be stored, which may possible lead to an enormous size of data.

### BRIEF DESCRIPTION OF THE DRAWINGS

FIG. 1 is a block diagram showing an example of the configuration of a simulation device according to a first embodiment.

FIGS. 2A, and 2B are oblique perspective views explaining an example of calculation processing according to the first embodiment.

FIG. 3 is a flow chart showing an example of the operation of the simulation device according to the first embodiment.

FIG. 4 is a flow chart showing an example of the display operation of the simulation device according to the first embodiment.

FIG. 5 is an oblique perspective view of an example of stacking the same three-dimensional shape data items according to a second embodiment.

FIGS. 6A, and 6B are oblique perspective views of repetitive calculation according to the second embodiment.

FIG. 7 is an oblique perspective view of calculation formula groups according to a third embodiment.

FIG. 8 is a diagram showing an example of a display image according to the third embodiment.

### DETAILED DESCRIPTION

A storage medium storing a simulation program according to the present embodiment stores a simulation program for making a simulation device having a calculation unit and a storage carry out a simulation of the shape of a semiconductor device. In accordance with the program, the simulation device simulates a manufacturing process using first three-dimensional shape data to calculate second three-dimensional shape data. Third three-dimensional shape data is calculated as a difference between the first three-dimensional shape data and the second three-dimensional shape data. Data about a calculation formula for calculating the second three-dimensional shape data from the first three-dimensional shape data by using the third three-dimensional shape data is generated. A data size of data including the data about the calculation formula and the third three-dimensional shape data is compared to a data size of the second three-dimensional shape data, and the data having a smaller data size is stored in the storage.

Embodiments will now be explained with reference to the accompanying drawings.

### First Embodiment

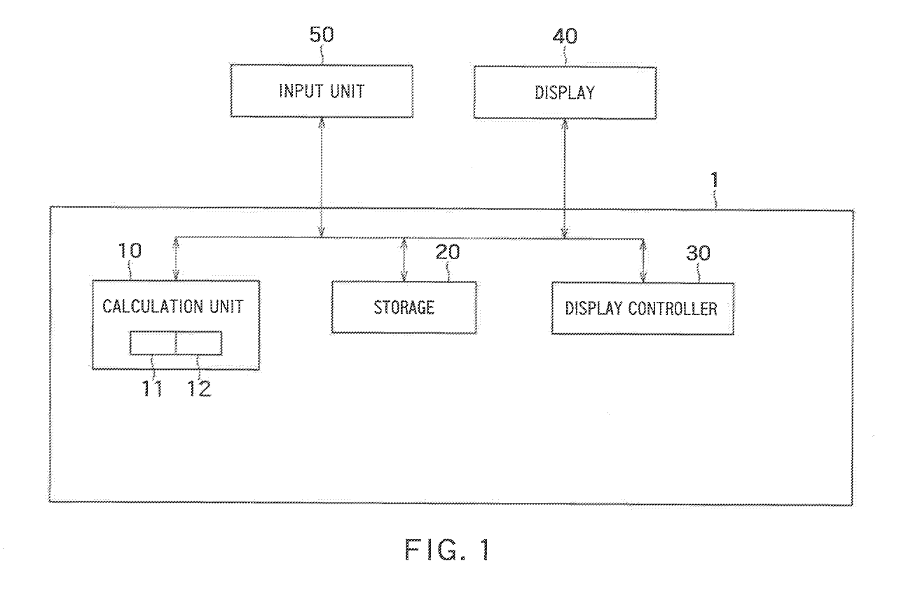

FIG. 1 is a block diagram showing an example of the configuration a simulation device 1 for simulating the shape of a semiconductor device (hereinafter referred to also simply as “simulation device”) according to a first embodiment. The simulation device 1 has a calculation unit 10, a storage 20, a display controller 30, a display 40, and an input unit 50. The simulation device 1 is a computer for example.

The calculation unit 10 has a central processing unit (CPU) 11 and a main memory 12. Each component of the simulation device 1 is controlled when the CPU 11 executes a simulation program (hereinafter referred to also simply as “program”) stored in the main memory 12 to simulate the shape of a semiconductor device. Thus, the processes explained below and in flow charts are realized when the CPU 11 executes the program stored in the main memory 12.

The storage 20 stores data concerning mask layout, manufacturing conditions, various measurement data, etc. required for the simulation. The user operates the input unit 50 to input various commands (for instruction, selection, order, numerical value, etc.) into the simulation device 1. The input unit 50 is a mouse or a keyboard, for example. The execution situation of the program executed by the calculation unit 10 and results obtained thereby are displayed on the display 40 through the display controller 30.

Note that the first embodiment also covers program codes of a program installed in the simulation device 1 in order that the simulation device 1 realizes the functional processing of the first embodiment. Thus, the first embodiment also includes a recording medium recording these program codes. In other words, the first embodiment includes a simulation program for simulating the shape of a semiconductor device to realize the, functional processing of the first embodiment, and a recording medium thereof.

The simulation device 1 having the above components makes it possible to simulate each manufacturing process of a semiconductor device, such as an etching process and a deposition process. Such a simulation of the manufacturing process is called TCAD (technology computer-aided design) for example.

Next, the operation of the calculation unit 10 will be explained in detail.

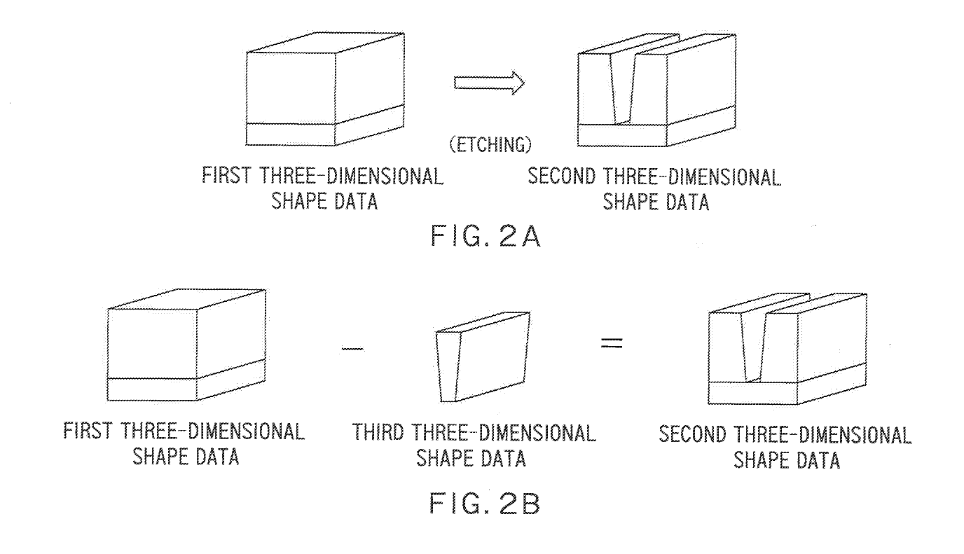

Each of FIG. 2A and FIG. 2B is oblique perspective view explaining an example of the processing operation of the simulation device 1. In the present embodiment, the calculation unit 10 simulates an etching process as one of semiconductor manufacturing processes.

In FIG. 2A, the image on the left is an image based on referential shape data (first three-dimensional shape data) before the simulation. On the other hand, in FIG. 2A, the image on the right is an image based on resultant shape data (second three-dimensional shape data) after the simulation. The resultant shape data is three-dimensional shape data showing a calculation result obtained by the calculation unit 10 by simulating the etching process based on the referential shape data.

The user checks the image based on the resultant shape data, and considers process conditions etc. for each manufacturing process.

The manufacturing process simulation is performed by using repetitive calculation based on Monte Carlo simulation, for example. Accordingly, if the manufacturing process simulation is performed each time the image based on the resultant shape data is displayed, a long time is required. Therefore, the resultant shape data may be stored in the storage 20 after the simulation in order to display, on the display 40, the image based on the resultant shape data as needed.

However, if the resultant shape data about all processes is previously stored in the storage 20, the data size thereof becomes enormous due to the increase in the complexity of device shape and the number of processes included in the semiconductor manufacturing process flow. Thus, it is required to reduce the data size of the resultant shape data in each process.

The simulation device 1 according to the present embodiment makes it possible to reduce the data size by using differential shape data (third three-dimensional shape data) and calculation formulas.

FIG. 2B shows an example of a calculation formula using referential shape data, resultant shape data, and differential shape data.

The calculation unit 10 simulates a certain process based on referential shape data, to obtain resultant shape data. Next, the calculation unit 10 performs simulation based on the referential shape data and resultant shape data, to calculate differential shape data. Further, the calculation unit 10 generates a calculation formula for calculating the resultant shape data from the referential shape data by using the differential shape data. The calculation formula is a formula expressed with the identifier of the referential shape data, the identifier of the differential shape data, and operators showing four arithmetic operations, for example. The calculation formula is used to obtain the resultant shape data from the referential shape data and differential shape data by performing addition (+), subtraction (−), etc. therebetween. The identifier, which should not be particularly limited, may be arbitrary data or an arbitrary address capable of identifying the referential shape data or differential shape data. Note that the calculation formula of FIG. 2B is shown using three-dimensional shape for easy understanding.

For example, the calculation formula shown in FIG. 2B corresponds to an etching process. When simulating the etching process, the resultant shape is obtained by etching the referential shape, which means that the resultant shape becomes smaller than the referential shape by the differential shape. Therefore, in the calculation formula shown in FIG. 2B, the differential shape data is subtracted (−) from the referential shape data. Based on the calculation formula shown in FIG. 2B, the resultant shape data can be obtained.

Although not shown in FIG. 2B, when simulating a deposition process, the resultant shape becomes larger than the referential shape by the differential shape. Therefore, in the calculation formula in this case, the differential shape data is added (+) to the referential shape data. The calculation unit 10 can obtain the resultant shape data in the deposition process by executing this calculation formula.

The calculation unit 10 stores, in the storage 20, the referential shape data, differential shape data, and calculation formulas in order to display a resultant shape responding to a request from the user. When the user requests to display a resultant shape, the calculation unit 10 generates resultant shape data by using a calculation formula and differential shape data. Thus, the display 40 can display the resultant shape. For example, when a calculation formula for an etching process shows “the identifier of referential shape data−the identifier of differential shape data,” the calculation unit 10 subtracts the differential shape data from the referential shape data to obtain resultant shape data. For example, when a calculation formula for a deposition process shows “the identifier of referential shape data +the identifier of differential shape data,” the calculation unit 10 adds the differential shape data to the referential shape data to obtain resultant shape data.

Here, the data size of the combination of the differential shape data and calculation formula is often smaller than the data size of the resultant shape data. In such a case, the calculation unit 10 stores, in the storage 20, the differential shape data and calculation formula, instead of storing the resultant shape data. This makes it possible to reduce the size of data required to display a resultant shape. In some cases, the data size of the combination of the differential shape data and calculation formula becomes larger than the data size of the resultant shape data. In such a case, the calculation unit 10 stores the resultant shape data directly in the storage 20, instead of storing the differential shape data and calculation formula in the storage 20.

As stated above, the calculation unit 10 compares the data size of the combination of the differential shape data and calculation formula with the data size of the resultant shape data, and stores the data having a smaller data size in the storage 20. Accordingly, the size of three-dimensional shape data to be stored in the storage 20 becomes at least the data size of the resultant shape data or smaller.

Note that the data format of three-dimensional shape data such as the referential shape data, differential shape data, and resultant shape data to be stored in the storage 20 should not be particularly limited. For example, the following format may be employed. For example, the three-dimensional shape data is composed of header information, coordinates of vertexes of the three-dimensional shape data (xn, yn, zn), sides each shown by the combination of the vertexes, planes each shown by the combination of the sides, and information about each material between the planes. More specifically, the three-dimensional shape data is composed of the following information, for example: header information {process number}; vertexes {vertex 1:(x1, y1, z1), vertex 2:(x2, y2, z2) . . . vertex n:(xn, yn, zn)}; sides {side 1:(vertex 1, vertex 2), side 2:(vertex 3, vertex 4) . . . }, planes {plane 1:(side 1, side 2, side 3) . . . }; and materials {Si(between plane 1 and plane 2), SiO₂(between plane 3 and plane 4), . . . }. In this way, the three-dimensional shape data is composed of the information about vertexes, sides, planes, etc. Thus, as the shape becomes more complicated, the data size becomes more enormous. Therefore, it is considered that a simple shape having a smaller number of vertexes, sides, planes, etc. has a smaller data size. Note that the data format should not be limited to the above example.

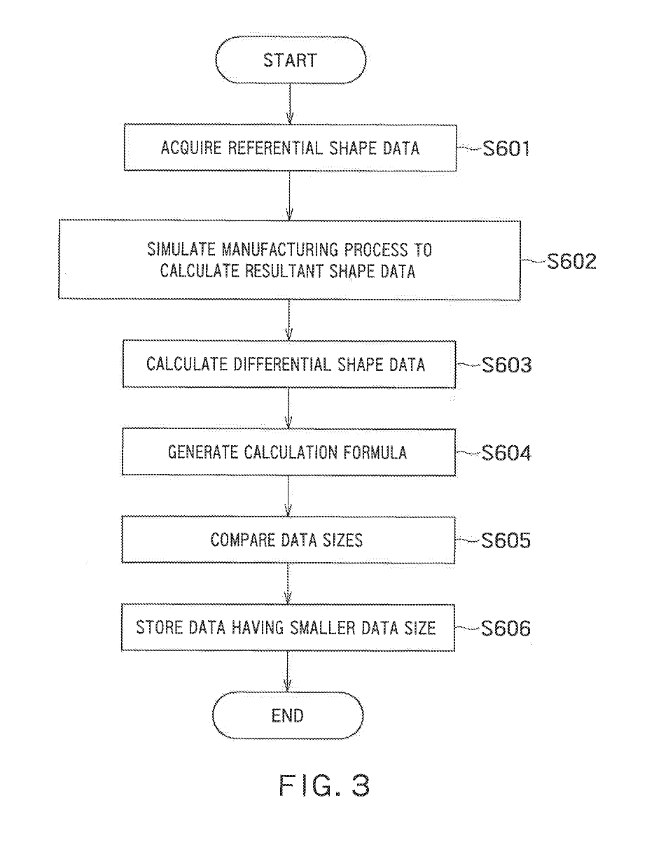

FIG. 3 is a flow chart showing an example of the steps performed by the simulation device 1 according to the first embodiment to store, in the storage 20, resultant shape data or the combination of differential shape data and a calculation formula.

First, the calculation unit 10 acquires referential shape data from the storage 20 (Step S601). The process corresponding to the referential shape data may be the first process or intermediate process in the semiconductor manufacturing process flow.

Next, the calculation unit 10 simulates the manufacturing process using the referential shape data as the original shape, to obtain resultant shape data (Step S602).

Next, the calculation unit 10 calculates differential shape data between the referential shape data and resultant shape data (Step S603).

Next, the calculation unit 10 generates a calculation formula for calculating the resultant shape data from the referential shape data by using the differential shape data (Step S604). As stated above, the calculation formula is a formula including the identifier of the referential shape data, the identifier of the differential shape data, and operators.

Next, the calculation unit 10 compares the total data size of the data about the calculation formula and the differential shape data with the data size of the resultant shape data (Step S605), Based on the comparison result, the calculation unit 10 stores, in the storage 20, the data having a smaller data size between the resultant shape data and the combination of the differential shape data and calculation formula (Step S606).

By storing the data having a smaller data size between the resultant shape data and the combination of the differential shape data and calculation formula as stated above, the size of three-dimensional shape data to be stored in the storage 20 as a simulation result can be reduced to the size of the resultant shape data or smaller.

Note that the combination of the differential shape data and calculation formula cannot be used as referential shape data when simulating the next process. However, the resultant shape data, which shows a device shape itself, can be used as referential shape data when simulating the next process. In this case, the calculation unit 10 performs the steps of FIG. 3 using the resultant shape data as referential shape data, to obtain resultant shape data in the next process. Further, the calculation unit 10 can store, in the storage 20, the data having a smaller data size between the resultant shape data and the combination of the differential shape data and calculation formula corresponding to the next process.

The steps of FIG. 3 may be carried out on every process in the semiconductor manufacturing process flow. Accordingly, the data having a smaller data size between the resultant shape data and the combination of the differential shape data and calculation formula can be stored in the storage 20 with respect to every process in the semiconductor manufacturing process flow. Since there are many semiconductor manufacturing processes, carrying out the steps shown in FIG. 3 on every process in the semiconductor manufacturing process flow makes it possible to considerably reduce the size of data stored in the storage 20.

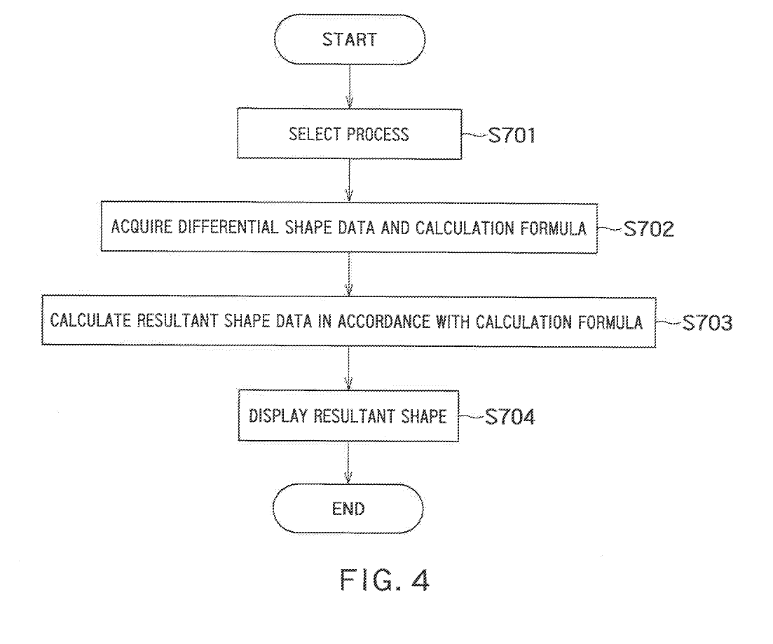

FIG. 4 is a flow diagram showing an example of the steps performed by the simulation device 1 according to the first embodiment to display resultant shape data.

First, the user selects a process corresponding to a device shape desired to be displayed on the display 40, by using the input unit 50 (Step S701).

Next, the calculation unit 10 acquires, from the storage 20, referential shape data corresponding to the selected process. At this time, the referential shape data is data about a device shape in a process performed prior to the selected process. Further, the calculation unit 10 acquires, from the storage 20, the resultant shape data or the combination of the differential shape data and calculation formula corresponding to the selected process (Step S702).

When the data acquired from the storage 20 is resultant shape data, the calculation unit 10 directly displays, on the display 40, an image based on the resultant shape data, without performing calculation using referential shape data, differential shape data, and calculation formula.

When the data acquired from the storage 20 is the combination of differential shape data and a calculation formula, the calculation unit 10 calculates resultant shape data from the referential shape data and differential shape data in accordance with the calculation formula (Step S703).

Next, the calculation unit 10 displays an image based on the resultant shape data on the display 40 through the display controller 30 (Step S704).

After checking the resultant shape data, the user may perform the simulation again changing simulation conditions.

Note that the referential shape data does not always correspond to the process performed immediately before the process corresponding to a desired device shape (hereinafter, referred to also as “target process”), and may be three-dimensional shape data corresponding to a process performed before the target process with a plurality of processes therebetween. This is because the referential shape data should be stored not as the combination of differential shape data and a calculation formula but as data about a device shape itself (resultant shape data). In this case, in order to obtain the resultant shape data in the target process, the calculation formula for the target process should include calculations on a plurality of processes from the process corresponding to the referential shape data to the target process.

As stated above, in the simulation device 1 according to the present embodiment, an image based on resultant shape data can be displayed on the display 40 by using differential shape data and calculation formula in a selected certain target process in the semiconductor process flow.

The simulation device 1 according to the present embodiment stores, in the storage 20, the data having a smaller data size between the resultant shape data and the combination of the differential shape data and calculation formula. This makes it possible to reduce the size of three-dimensional shape data to he stored in the storage 20 as a simulation result to at least the size of the resultant shape data or smaller.

In the above example, explanation was given on the simulation of one process. If each process in the semiconductor process flow is simulated using the above steps, data size of the entire three-dimensional shape data in the semiconductor process flow can be reduced. Since the semiconductor process flow consists of many processes, the present embodiment makes it possible to considerably reduce the data size.

### Second Embodiment

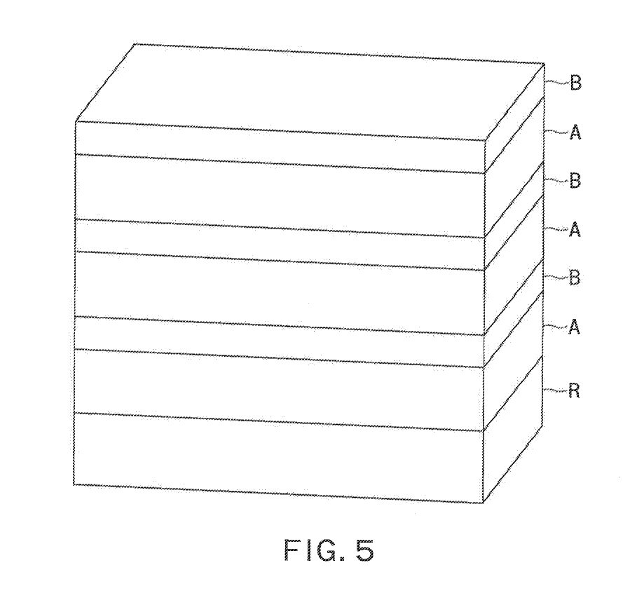

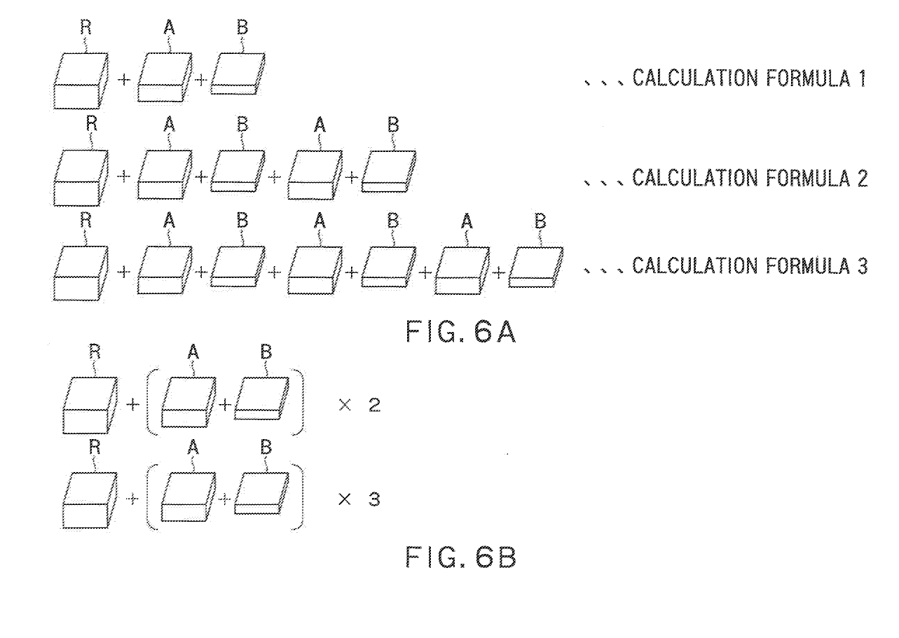

FIG. 5 is an oblique perspective view explaining an example of the processing operation of the simulation device 1 according to a second embodiment. Each of FIG. 6A and FIG. 6B is an oblique perspective view showing an example of the calculation formulas used in the process shown in FIG. 5. The second embodiment is provided to simulate a structure obtained by stacking or arranging a plurality of same three-dimensional shape data items. The second embodiment can be applied to a structure obtained by stacking same three-dimensional shape data items, such as a multi-layer wiring structure and a stacked gate structure of a three-dimensional memory.

FIG. 5 shows a structure in the middle of forming a stacked gate structure as an example, in which a gate electrode material A and a gate dielectric film material B are repeatedly stacked. In this case, the calculation formulas shown in FIG. 6A are obtained when expressing the structure by using differential shape data and calculation formulas as in the first embodiment.

The calculation formula 1 of FIG. 6A expresses that a layer of the gate electrode material A and a layer of the gate dielectric film material B are stacked on referential shape data one by one. The calculation formula 2 expresses that the gate electrode material A and gate dielectric film material B are stacked on the referential shape data in the order of material A, material B, material A, and material B. The calculation formula 3 expresses that the gate electrode material A and gate dielectric film material B are stacked on the referential shape data in the order of material A, material B, material A, material B, material A, and material B. The structure shown in FIG. 5 is displayed on the display 40 when the calculation unit 10 executes the calculation formula 3.

Here, in the calculation formula 2 and calculation formula 3, a plurality of three-dimensional shape data items about the gate electrode material A and a plurality of three-dimensional shape data items about the gate dielectric film material B should be stored in the storage 20 as differential shape data. This means that the same differential shape data items are redundantly stored in the storage 20.

Therefore, in the calculation formula shown in FIG. 6B, multiplication (×) is used. Specifically, the calculation formula 2 can be expressed as follows: (three-dimensional shape data about the gate electrode material A+three-dimensional shape data about one of a plurality of gate dielectric film materials B)×2. The calculation formula 3 can be expressed as follows: (three-dimensional shape data about the gate electrode material A+three-dimensional shape data about one of a plurality of gate dielectric film materials B)×3. Specifically, this multiplication expresses the repetition of the same three-dimensional shape data. When the calculation formula includes multiplication, it is desirable that the calculation formula includes shift calculation (not shown) to prevent a plurality of material A layers and a plurality of materials B layers from overlapping in the same position due to the multiplication. The shift calculation is performed to shift the position coordinates of the material A layers and material B layers from each other to prevent the layers overlap with each other. For example, in the calculation formula 2 of FIG. 6B, after the material A layer and the material B layer are stacked on the referential shape data one by one, the second material A layer is shifted upward by the film thickness of the first material A layer and first material B layer based on the shift calculation. The second material B layer is shifted upward by the film thickness of the two (first and second) material A layers and first material B layer based on the shift calculation.

In this way, the second material A layer and second material B layer can be displayed.

Each of the calculation formula 2 and calculation formula 3 shown in FIG. 6B uses multiplication, which is expressed using three-dimensional shape data about the gate electrode material A and three-dimensional shape data about one of a plurality of gate dielectric film materials B only once respectively. This makes it possible to reduce the size of three-dimensional shape data to be stored in the storage 20, which means that the size of three-dimensional shape data to be stored in the storage 20 as a simulation result can be further reduced.

### Third Embodiment

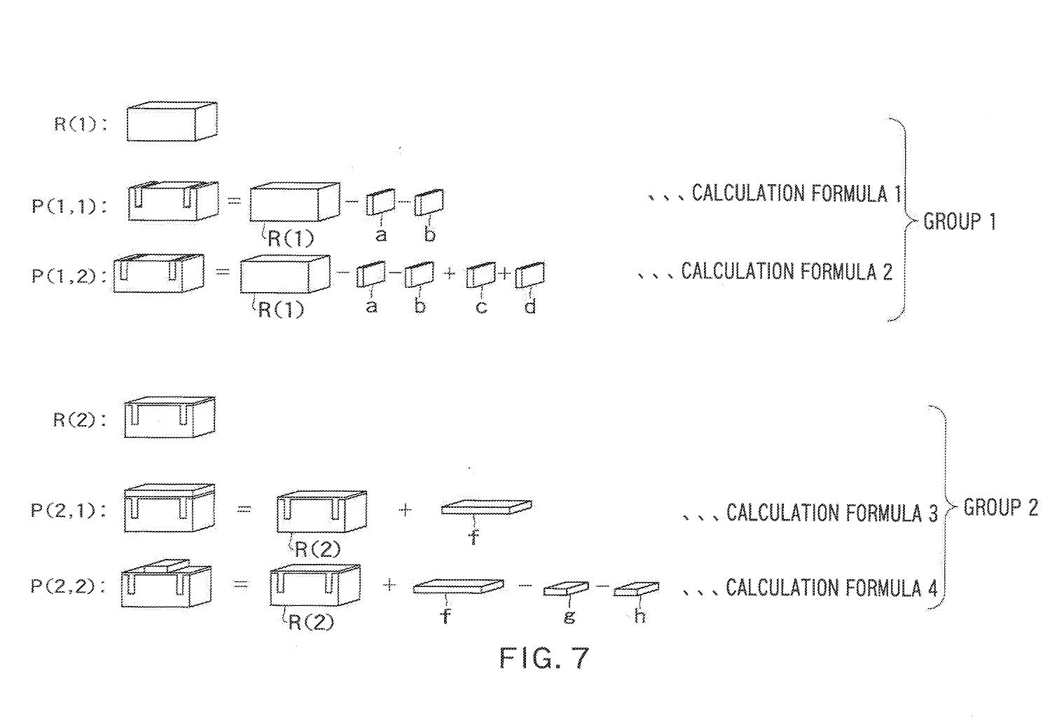

FIG. 7 is an oblique perspective view showing an example of the calculation formula used by the simulation device 1 according to a third embodiment. The simulation device 1 according to the first embodiment calculates resultant shape data for a process following (immediately after) the process corresponding to certain referential shape data. However, when the same referential shape data is used in the calculation for many subsequent processes, many differential shape data items are required from the process corresponding to certain referential shape data to the target process. In addition, the calculation unit 10 should calculate many differential shape data items related to the reference data, to obtain resultant shape data in the target process. In this case, the volume of data to be stored in the storage 20 increases, and the load on the calculation unit 10 also increases.

Accordingly, in the third embodiment, a process corresponding to certain referential shape data (hereinafter referred to as “referential process”) is set at several-process intervals, and a plurality of processes performed from a certain referential process to the next referential process are merged into a group.

The group 1 shown in FIG. 7 includes the processes from a referential process corresponding to referential shape data R(1) to a process immediately before the next referential process corresponding to referential shape data R(2). The group 2 includes the processes from a referential process corresponding to the referential shape data R(2) to a process immediately before the next referential process corresponding to referential shape data R(3).

Each of P(1,1) and P(1,2) in the group 1 shows resultant shape data, differential shape data, and a calculation formula obtained by simulating each subsequent process by using the referential shape data R(1).

Each of P(2,1) and P(2,2) in the group 2 shows resultant shape data, differential shape data, and a calculation formula obtained by simulating each subsequent process by using the referential shape data R(2).

In FIG. 7, the resultant shape data items P(1,1), P(1,2), P(2,1), and P(2,2) is shown expediently. However, since the referential shape data R(1) and R(2), differential shape data, and calculation formulas are the data to be stored in the storage 20, the resultant shape data items P(1,1), P(1,2), P(2,1), P(2,2) are not actually stored in the storage 20.

The calculation formula 1 of FIG. 7 expresses etching differential shape data a and b from the referential shape data R(1). The calculation formula 2 expresses etching the differential shape data a and b from the referential shape data R(1), and further stacking differential shape data c and d thereon.

The calculation unit 10 executes the calculation formula 1 and calculation formula 2 to make it possible to display, on the display 40, images based on the resultant shape data P(1,1) and P(1,2) in the group 1.

Similarly, the calculation formula 3 expresses stacking differential shape data f on the referential shape data R(2). The calculation formula 4 expresses stacking the differential shape data f on the referential shape data R(2) and etching differential shape data g and h therefrom.

The calculation unit 10 executes the calculation formula 3 and calculation formula 4 to make it possible to display, on the display 40, images based on the resultant shape data P(2,1) and P(2,2) in the group 2.

In this way, in the group 2, calculation formulas are generated based on the referential shape data R(2).

In this case, each calculation formula can be shortened compared to the case of obtaining the resultant shape data P(2,1) and P(2,2) from the referential shape data R(1). Further, calculation time can be shortened compared to the calculation time taken to obtain the resultant shape data P(2,1) and P(2,2) from the referential shape data R(1).

There may be a case where the calculation formula 1 and calculation formula 2 include a plurality of same differential shape data items. For example, when the differential shape data a is the same as the differential shape data b, differential shape data items about the same shape are redundantly stored in the storage 20. Therefore, in the present embodiment, when differential shape data in the each process includes a plurality of same differential shape data items, those are expressed using multiplication (×). For example, in the calculation formula 1, when the differential shape data a is the same as the differential shape data b, the calculation formula 1 can be expressed as follows: R(1)−(differential shape data a)×2. Further, in the calculation formula 2, when the differential shape data c is the same as the differential shape data d, the calculation formula 2 can be expressed as follows: R(1)−(differential shape data a)×2+(differential shape data c)×2. In this case, there is no need to redundantly store the same differential shape data items in the storage 20, which makes it possible to reduce the data size of the three-dimensional shape data in the storage 20.

In the above three-dimensional shape data, the combination of vertexes shows each side, and the combination of sides shows each plane. Accordingly, it is considered that that a simple shape having a smaller number of vertexes, sides, planes, etc. has a smaller data size. For example, the number of vertexes used to express three-dimensional shape data is considered as a representative index of the size of the three-dimensional shape data. In this case for example, when actually counting the number of vertexes of the three-dimensional shape data in the processes of the group 1, each of the resultant shape data P(1,1) and resultant shape data P(1,2) has 24 vertexes, which means that the total number of vertexes is 48. On the other hand, each of differential shape data items in the two processes corresponding to the resultant shape data P(1,1) and resultant shape data P(1,2) has 8 vertexes, which means that the total number of vertexes is 32. Further, when using multiplication (×), the total number of vertexes of the differential shape data items in the above two processes becomes 16. In this way, the calculation formula using differential shape data makes it possible to reduce the size of three-dimensional shape data to be stored in the storage 20. Further, using multiplication (×) makes it possible to further reduce the size of three-dimensional shape data to be stored in the storage 20.

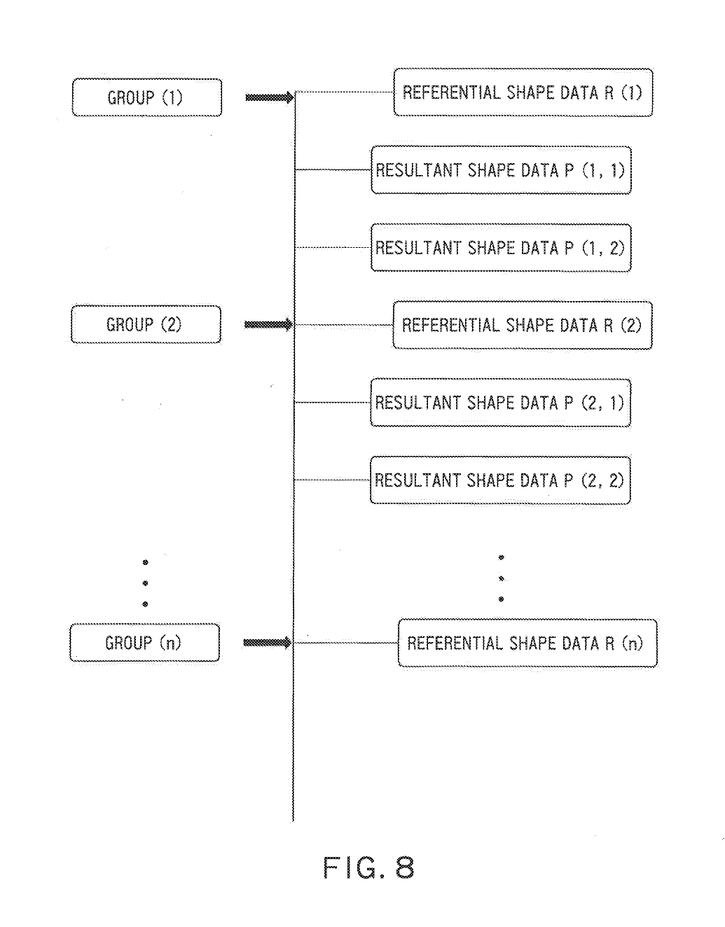

FIG. 8 is a diagram showing an example of an image used to display a simulation result according to the third embodiment. The user selects a desired group or a desired process shown in this image by using the input unit 50. The display correspondingly displays resultant shape data in all processes included in the group or resultant shape data in a desired process. The resultant shape data corresponding to the process is displayed on the display 40.

For example, when resultant shape data in a certain process is selected, the calculation unit 10 calculates resultant shape data using a calculation formula corresponding to the process. Next, the display 40 displays the calculated resultant shape data.

Further, for example, when a certain group n is selected, the display 40 sequentially displays referential shape data R(n), resultant shape data P(n,1), and resultant shape data P(n,2). For example, when n=1, the calculation unit 10 calculates the calculation formula 1 of FIG. 7 first, and then calculates the calculation formula 2. The calculation formula 2 includes the calculation formula 1. Therefore, executing the calculation formula 1 means completing a part of calculation of the calculation formula 2. Thus, after calculating the calculation formula 1, the calculation formula 2 can be calculated by executing the remaining calculation part which is not included in the calculation formula 1.

As stated above, by selecting a group, resultant shape data items in the group can be sequentially displayed. In this case, the calculation result in the previous process can be used in the calculation for the next process, which makes it possible to effectively calculate resultant shape data.

Each group may be arbitrarily set. For example, each group may be set corresponding to a predetermined number of processes. Instead, each group may be set corresponding to the stages in a specific process. For example, a group may be set corresponding to the stages in a lithography process. In this case, the referential shape data to be used is three-dimensional shape data immediately before the lithography process. Setting a group corresponding to the stages in the lithography process makes it possible to effectively watch the resultant shape data obtained after each stage in the lithography process.

As stated above, in the simulation device 1 according to the present embodiment, a referential process corresponding to referential shape data is set at several-process intervals, and a plurality of processes performed from a certain referential process to the next referential process are merged into a group. This makes it possible to reduce the data size of each calculation formula to be stored in the storage 20 as a simulation result. Further, time taken to calculate the resultant shape data can be reduced.

At least a part of the data processing method in the simulation device 1 according to the above embodiments may be formed of hardware or software. In the case of software, a program realizing at least a partial function of the data processing method may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc. Further, a program realizing at least a partial function of the data processing method can be distributed through a communication line (including radio communication) such as the Internet. Furthermore, this program may be encrypted, modulated, and compressed to be distributed through a wired line or a radio link such as the Internet or through a recording medium storing it therein.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A storage medium storing a simulation program for making a simulation device having a calculation unit and a storage carry out a simulation of the shape of a semiconductor device,
the simulation program making the simulation device carry out:
simulating a manufacturing process using first three-dimensional shape data to calculate second three-dimensional shape data;
calculating third three-dimensional shape data as a difference between the first three-dimensional shape data and the second three-dimensional shape data;
calculating data about a first calculation formula for calculating the second three-dimensional shape data from the first three-dimensional shape data by using the third three-dimensional shape data; and
comparing a data size of combined data of the data about the first calculation formula and the third three-dimensional shape data with a data size of the second three-dimensional shape data, to store the data having a smaller data size in the storage.

2. The storage medium of claim 1, wherein the storage medium stores a simulation program for making the simulation device generate the first calculation formula which describes a method of generating the second three-dimensional shape data from the first three-dimensional shape data by using a plurality of differential three-dimensional shape data items included in the third three-dimensional shape data.

3. The storage medium of claim 1, wherein the storage medium stores a simulation program for making the simulation device describe the first calculation formula as multiplication when describing a method of generating the second three-dimensional shape data from the first three-dimensional shape data by using the differential three-dimensional shape data a plurality of times.

4. The storage medium of claim 1, wherein in the process of calculating the data about the first calculation formula, the storage medium stores a simulation program for making the simulation device carry out:
calculating, when simulating an etching process, a calculation formula for subtraction to obtain the second three-dimensional shape data by subtracting the third three-dimensional shape data from the first three-dimensional shape data; and
calculating, when simulating a deposition process, a calculation formula for addition to obtain the second three-dimensional shape data by adding the third three-dimensional shape data to the first three-dimensional shape data.

5. The storage medium of claim 1, wherein the storage medium stores a simulation program for making the simulation device treat the first three-dimensional shape data as three-dimensional shape data at the start of a lithography process.

6. The storage medium of claim 1, wherein the storage medium stores a simulation program for making the simulation device define the first three-dimensional shape data as three-dimensional shape data obtained by performing calculation a predetermined number of times after the simulation of the shape of the semiconductor device is started.

7. The storage medium of claim 1, wherein the storage medium stores a simulation program for making the simulation device display, on a display, an image based on the second three-dimensional shape data generated by using the data stored in the storage.

8. The storage medium of claim 7, wherein the storage medium stores a simulation program for making the simulation device carry out:
acquiring, from the storage, a calculation formula for calculating the second three-dimensional shape data from the first three-dimensional shape data by using the third three-dimensional shape data; and
calculating the second three-dimensional shape data in accordance with the acquired calculation formula.

9. A simulation device comprising:
a calculation unit to be able to calculate third three-dimensional shape data as a difference between first three-dimensional shape data and second three-dimensional shape data calculated by simulating a semiconductor manufacturing process using the first three-dimensional shape data, to be able to calculate data about a calculation formula for calculating the second three-dimensional shape data from the first three-dimensional shape data by using the third three-dimensional shape data, and to compare a data size of first data including the data about the calculation formula and the third three-dimensional shape data with a data size of the second three-dimensional shape data; and
a storage to store the data having a smaller data size in the first data and the second three-dimensional shape data, based on the comparison.

10. The simulation device of claim 9, wherein when the third three-dimensional shape data has a plurality of differential three-dimensional shape data items, the calculation unit describes, as the first calculation formula, a method of generating the second three-dimensional shape data from the first three-dimensional shape data by using the differential three-dimensional shape data items.

11. The simulation device of claim 9, wherein when describing a method of generating the second three-dimensional shape data from the first three-dimensional shape data by using the differential three-dimensional shape data a plurality of times, the calculation unit describes the calculation formula as multiplication.

12. The simulation device of claim 9,
wherein when simulating an etching process, the calculation unit describes, as the first calculation formula, a calculation formula for subtraction to obtain the second three-dimensional shape data by subtracting the third three-dimensional shape data from the first three-dimensional shape data, and
when simulating a deposition process, the calculation unit describes, as the first calculation formula, a calculation formula for addition to obtain the second three-dimensional shape data by adding the third three-dimensional shape data to the first three-dimensional shape data.

13. The simulation device of claim 9, wherein the first three-dimensional shape data is three-dimensional shape data obtained by performing calculation a predetermined number of times after the simulation of the shape of the semiconductor device is started.

14. The simulation device of claim 9, wherein the calculation unit displays, on a display, an image based on the second three-dimensional shape data generated by using the data stored in the storage.

15. The simulation device of claim 14, wherein the calculation unit acquires, from the storage, a calculation formula for calculating the second three-dimensional shape data from the first three-dimensional shape data by using the third three-dimensional shape data, and calculates the second three-dimensional shape data in accordance with the acquired calculation formula.

16. A simulation method, comprising:
inputting a selection signal for selecting a second three-dimensional shape;
acquiring, from the storage, a calculation formula for calculating the second three-dimensional shape data from the first three-dimensional shape data by using the third three-dimensional shape data, in accordance with the selection signal;
calculating the second three-dimensional shape data in accordance with the acquired calculation formula; and
displaying, on a display, an image based on the second three-dimensional shape data.
